(19) United States
(12) Patent Application Publication
(10) Pub. No.: US 2003/0200330 A1
(43) Pub. Date: Oct. 23, 2003

(54) System and method for load-sharing computer network switch

(75) Inventors: Mark Lyndon Oelke, Spring, TX (US); John E. Jenne, Houston, TX (US); Sompong Paul Olarig, Pleasanton, CA (US)

Correspondence Address: BAKER BOTTS, LLP, 910 LOUISIANA, HOUSTON, TX, 77002-4995, US

(73) Assignee: MaXXan Systems, Inc.

(21) Appl. No.: 10/127,806

(22) Filed: Apr. 22, 2002

(51) Int. Cl. G06F 15/173

(52) U.S. Cl. 709/238

(57) ABSTRACT

A computer network switch system is disclosed. A switch system may be configured as a single chassis system that has at least one line card, a set of active switch fabric cards to concurrently carry network traffic; and a first system control card to provide control functionality for the line card. The switch system may be configured as a multiple chassis system that has at least one line card chassis containing several line cards, and a switch fabric chassis (or a second line card chassis) that contains several switch fabric cards to provide a switching fabric with multiple ports. Load-sharing is accomplished primarily at the chip level, although card-level load-sharing is possible.

### CROSS-REFERENCE TO RELATED APPLICATIONS

This application is related to U.S. patent application Ser. No. 09/738,960, entitled “Caching System and Method for a Network Storage System” by Lin-Sheng Chiou, Mike Witkowski, Hawkins Yao, Cheh-Suei Yang, and Sompong Paul Olarig, which was filed on Dec. 14, 2000 and which is incorporated herein by reference in its entirety for all purposes; U.S. patent application Ser. No. 10/015,047 [attorney docket number 069099.0102/B2] entitled “System, Apparatus and Method for Address Forwarding for a Computer Network” by Hawkins Yao, Cheh-Suei Yang, Richard Gunlock, Michael L. Witkowski, and Sompong Paul Olarig, which was filed on Oct. 26, 2001 and which is incorporated herein by reference in its entirety for all purposes; U.S. patent application Ser. No. 10/039,190 [attorney docket number 069099.0105/B5] entitled “Network Processor Interface System” by Sompong Paul Olarig, Mark Lyndon Oelke, and John E. Jenne, which was filed on Dec. 31, 2001, and which is incorporated herein by reference in its entirety for all purposes; U.S. patent application Ser. No. 10/039,189 [attorney docket number 069099.0106/B6-A] entitled “Xon/Xoff Flow Control for Computer Network” by Hawkins Yao, John E. Jenne, and Mark Lyndon Oelke, which was filed on Dec. 31, 2001, and which is incorporated herein by reference in its entirety for all purposes; U.S. patent application Ser. No. 10/039,184 [attorney docket number 069099.0107/B6-B] entitled “Buffer to Buffer Flow Control for Computer Network” by John E. Jenne, Mark Lyndon Oelke and Sompong Paul Olarig, which was filed on Dec. 31, 2001, and which is incorporated herein by reference in its entirety for all purposes; U.S. patent application Ser. No. 10/117,418 [attorney docket number 069099.0109/(client reference 115-02)], entitled “System and Method for Linking a Plurality of Network Switches,” by Ram Ganesan Iyer, Hawkins Yao and Michael Witkowski, which was filed Apr. 5, 2002 and which is incorporated herein by reference in its entirety for all purposes; U.S. patent application Ser. No. ______ [attorney docket number 069099.0111/(client reference 135-02)], entitled “System and Method for Expansion of Computer Network Switching System Without Disruption Thereof,” by Mark Lyndon Oelke, John E. Jenne, Sompong Paul Olarig, Gary Benedict Kotzur and Matthew John Schumacher, which was filed Apr. 5, 2002 and which is incorporated herein by reference in its entirety for all purposes; U.S. patent application Ser. No. 10/117,266 [attorney docket number 069099.0112/(client reference 220-02)], entitled “System and Method for Guaranteed Link Layer Flow Control,” by Hani Ajus and Chung Dai, which was filed Apr. 5, 2002 and which is incorporated herein by reference in its entirety for all purposes; U.S. patent application Ser. No. 10/117,638 [attorney docket number 069099.0113/(client reference 145-02)], entitled Fibre Channel Implementation Using Network Processors,” by Hawkins Yao, Richard Gunlock and Po-Wei Tan, which was filed Apr. 5, 2002 and which is incorporated herein by reference in its entirety for all purposes; U.S. patent application Ser. No. ______ [attorney docket number 069099.0114/(client reference 230-02)], entitled “Method and System for Reduced Distributed Event Handling in a Network Environment,” by Ruotao Huang and Ram Ganesan Iyer, which was filed Apr. 5, 2002 and which is incorporated herein by reference in its entirety for all purposes; and U.S. patent application Ser. No. ______ [attorney docket number 069099.0115/(client reference 225-02)], entitled “System and Method for Allocating Unique Zone Membership,” by Walter Bramhall and Ruotag Huang, which was filed Apr. 15, 2002 and which is incorporated herein by reference in its entirety for all purposes.

### FIELD OF THE INVENTION

The present application is related to computer networks. More specifically, the present application is related to providing fault tolerance for a computer network.

### BACKGROUND OF THE INVENTION TECHNOLOGY

Computer network switches filter or forward data between various segments or sections of the computer network. Depending upon the type of traffic being passed, switches generally either perform circuit switching or packet switching. Circuit switching involves establishing end-to-end data paths through the switch in order to provide guaranteed bandwidth and latency. For example, circuit switching is typically employed by telecom equipment to route telephone calls. Packet switching, on the other hand, does not create dedicated links through the switch. Instead, packet switching rapidly directs individual packets of data from the ingress port to the desired egress port. Packet switching is generally used in the datacom domain. For example, Ethernet switches typically practice packet switching.

Switch fabric redundancy comes in the form of excess bandwidth. Part of the switch fabric can fail and there is “extra” bandwidth that can accept the traffic. In a telecom (e.g., circuit switched) environment a switch typically provides twice as much bandwidth as required to implement an “active” and “standby” path. If any part of the active path fails all traffic is switched over to the standby path. However, dual redundancy is a drastic and expensive solution. Dual redundancy requires additional components, signals, and software to maintain and manage a fail-over.

### SUMMARY OF THE INVENTION

The invention overcomes the above-identified problems as well as other shortcomings and deficiencies of existing technologies by providing a scalable and fault tolerance switch system.

In one embodiment of the present invention, the switch system may be configured as a single chassis system that has at least one line card, a set of active switch fabric cards to concurrently carry network traffic; and a system control card to provide control functionality for the line card. In another embodiment of the present invention, the switch system may be configured as a multiple chassis system that has at least one line card chassis containing several line cards, and a switch fabric chassis that contains several switch fabric cards to provide a switching fabric with multiple ports.

### BRIEF DESCRIPTION OF THE DRAWINGS

A more complete understanding of the present disclosure and advantages thereof may be acquired by referring to the following description taken in conjunction with the accompanying drawings, wherein:

FIG. 1a is a block diagram of an exemplary embodiment of a single chassis switch system of the present invention;

FIG. 1b is a block diagram of an exemplary embodiment of a single chassis switch system of the present invention;

FIG. 2 is a block diagram of an exemplary embodiment of a multiple chassis switch system of the present invention;

FIG. 3a is a block diagram illustrating the interconnections for an exemplary embodiment of a multiple chassis switch system;

FIG. 3b is a block diagram illustrating the interconnections for an exemplary embodiment of a multiple chassis switch system; and

FIG. 4 is a block diagram of an exemplary embodiment of a single chassis switch fabric card.

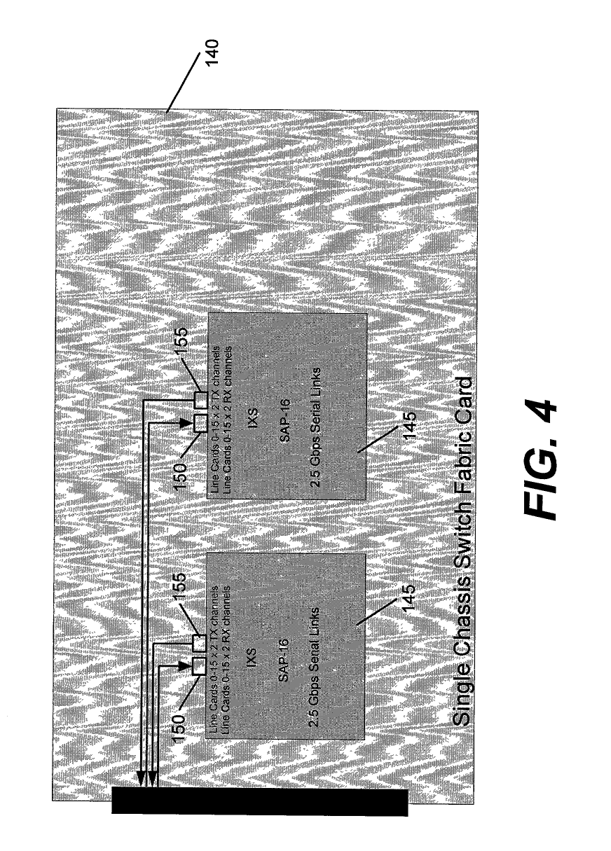

While the present invention is susceptible to various modifications and alternative forms, specific exemplary embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF EXEMPLARY EMBODIMENTS

The present invention relates to a switch system for a computer network, e.g., a storage area network (SAN), that is capable of load-sharing or active/active redundancy. According to an exemplary embodiment of the present invention, the load-sharing is done at the chip level, rather than at the card level, although load-sharing at the card level is possible on alternate embodiments. In addition, the switch system may be scalable and expanded from a single chassis to a multiple chassis to provide a larger number of network ports. The switch system may provide connectivity across a variety of different communication protocols, e.g., Fibre Channel, Gigabit (or faster) Ethernet, and internet SCSI (iSCSI), among others.

Generally, the switch system of the present invention may consist of several components: a rack-mountable chassis, a line card chassis backplane, a system control card, a switch fabric card, and a power chassis. Other exemplary embodiments of the present switch system may also include a switch fabric chassis backplane, a Fibre Channel card, a Gigabit (or faster) Ethernet card, and/or a chassis interconnect (CI) card (e.g., optical or copper). Note that the switch system need not contain all of these components. In addition, various exemplary embodiments of the present invention may have a different number or configuration of the aforementioned components.

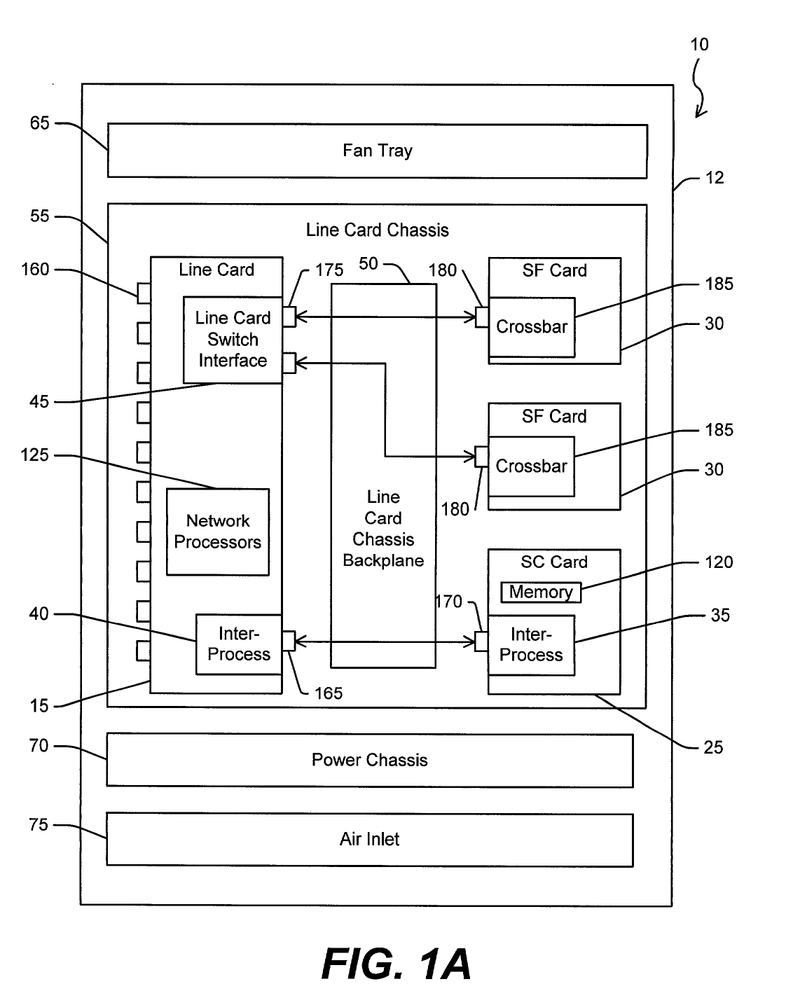

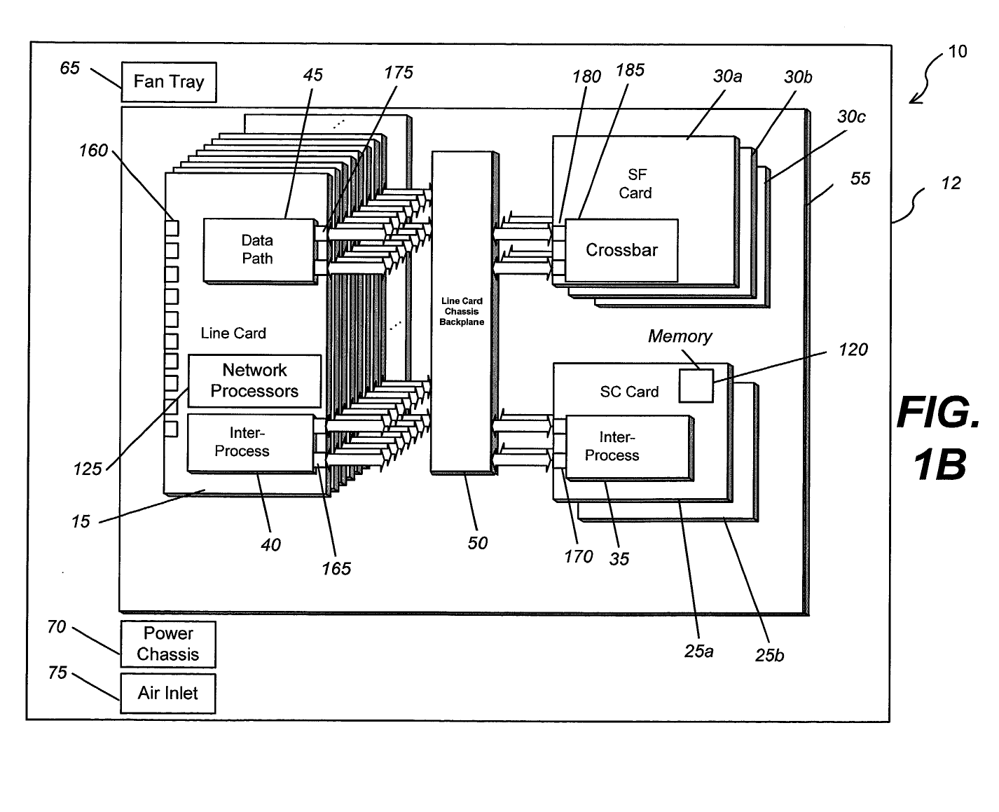

FIG. 1a shows a block diagram of an exemplary embodiment of the switch system, indicated generally at 10. The switch system 10 shown in FIG. 1a is configured as a single chassis 12 with one line card (LC) 15, one system control (SC) card 25, two switch fabric (SF) cards 30 and one line card chassis backplane 50. The switch fabric cards 30 are preferably not configured as a redundant pair (e.g., one switch fabric card is active and the other switch fabric card is a standby). Line card 15 may have several ports 160 to provide communicative connections with other network devices. The exemplary embodiment of line card 15 discussed throughout the present disclosure is a 10-port line card. It should be understood by one of ordinary skill in the pertinent arts that switch system 10 may implement line cards 15 that have a different number of ports (e.g., more or less than 10 ports.)

In the exemplary embodiment of FIG. 1a, switch system 10 has a single line card 15, one system control card 25 and two switch fabric cards. It should be understood by one of ordinary skill in the pertinent arts that switch system 10 may have any number of line cards 15 or system control cards 25. Furthermore, switch system 10 may have more switch fabric cards 30 than depicted in FIG. 1a. Each line card 15 has ports 165 and 175 that are used to interface to system control card(s) 25 and switch fabric card(s) 30. In one exemplary embodiment, system control card 25 contains one port 170 for each line card 15 for interprocess communications with that line card 15. This port may enable a dedicated interprocess link to each line card 15 that routes through the line card chassis backplane 50. Alternatively, switch system 10 may use a shared interprocess system such that system control card 25 has one port 170 that is shared by multiple line cards 15. Each switch fabric card 30 may use one or more dedicated ports 180 to form a private communications channel with each line card 15. These communication channels form the main data path. For example, for a switch system 10 that contains ten line cards 15, each switch fabric card 30 may have at least ten ports 180 such that each port may be connected with each line card 15.

Switch system 10 may utilize different types of line cards 15. For example, line card 15 may be a Fibre Channel line card, Gigabit Ethernet line card, cache memory line card, or any other type of line card. A Fibre Channel line card is designed to handle Fibre Channel protocol traffic. A Gigabit Ethernet line card is designed to handle Gigabit Ethernet protocol traffic. A cache memory line card is designed to provide caching functions for switch system 10. Other line cards 15 may be used to handle traffic for other network protocols, or perform other network functions or applications.

Line card 15 contains one or more network processors 125. Network processors 125 may support multiple frame or cell level protocols to process network traffic through line card 15. Examples of such protocols include, for example, Gigabit Ethernet, 10 Gigabit (10 Gbps) Ethernet, Gigabit Fibre Channel, 2 Gbs Fibre Channel, SONET OC-3, SONET OC-12, SONET-48, and other similar network protocols. The present invention, however, is scalable and is capable of working with protocols faster than 10 Gbps. Network processors 125 may also perform other functions such as table lookups, queue management, switch fabric interfacing, and buffer management, for example. Network processors 125 may also perform more general functions such as device management, software downloads, and interfacing to external processors.

Line card 15 may communicate with system control card 25 and switch fabric card 30. Line card 15 contains interprocess 40 to communicate with system control card 25 via interface ports 165. Similarly, system control card 25 contains interprocess 35 to communicate with line card 15 via interface ports 170. Accordingly, control and status information may be communicated between line card 15 and system control card 25. Interprocess 35 and 40 each provide a communications channel. Interprocess 35 and 40 may be any combination of hardware and software that forms an interprocess link to carry data between line card 15 and system control card 25. For example, interprocess 35 and 40 may be a shared serial channel such as HDLC. Alternatively, interprocess 35 and 40 may be a switched Ethernet link using a network protocol such as TCP/IP, for example. Line card 15 uses line card switch interface 45 to communicate with switch fabric card 30 via interface ports 175. Switch fabric card uses crossbar 185 to communicate with line card 15 via interface ports 180. As a result, network traffic may pass between switch fabric card 30 and line card 15.

Line card switch interface or data path 45 may reside on line card 15. Line card switch interface 45 preferably supports a range of line card speeds. For example, line card interface 45 may support line card speeds ranging from OC-12 to OC-192 (full duplex). Line card switch interface 45 incorporates a fabric switch interface protocol to provide a fabric switch interface to the line card devices attached to ports 160. For example, line card switch interface 45 may incorporate CSIX (Common Switch Interface) protocol to operate with a packet processor or traffic manager, and other CSIX-compatible devices. Line card switch interface 45 may negotiate the routing path through the switch fabric and transmit data in the ingress direction to crossbar 185. In the egress direction, line card switch interface 45 may receive data from crossbar 185 and transmit data to line card 15. Line card switch interface 45 may also manage a virtual output queue (VOQ) to manage data flow. One exemplary embodiment of line card switch interface 45 includes the ZSF202Q chip set manufactured by ZettaCom, Inc. of Santa Clara, Calif.

Crossbar 185 may reside on switch fabric card 30. Crossbar 185 may be an integrated crossbar and scheduler. Crossbar 185 may use non-blocking architecture and may support multiple classes of service (CoS) and spatial multicasting. Crossbar 185 may perform both data switching and circuit switching, concurrently. Crossbar 185 may include one or more chips suitable for providing crossbar functionality, depending on the desired switch system configuration. Crossbar 185 may have one or more chips that each preferably provide an aggregate bandwidth of at least about 40 Gbs full duplex. Crossbar 185 may have one or more chips that may each be configurable to support multiple system configurations, e.g., OC-12, OC-48, OC-192, etc. at 16-port, 32-port, 64-port, etc. One exemplary embodiment of crossbar 185 includes the ZSF200X chip set manufactured by ZettaCom, Inc. of Santa Clara, Calif.

Line card switch interface 45 and crossbar 185 are linked by multiple channels to provide switching and other communication functionality. For example, line card switch interface 45 and crossbar 185 may be connected by high-speed serial links. In one exemplary embodiment, for instance, the switch system may be configured for 24-channel load-sharing. Accordingly, line card switch interface 45 uses 24 of its high speed serial links for switching. Line card switch interface 45 and the crossbar 185 may also be linked to allow for monitoring functionality. Line card switch interface 45 may continuously monitor the integrity of its links with crossbar 185 in real time. Line card switch interface may therefore stop sending traffic to a faulty crossbar 185 and disable any channel in which it detects critical errors, e.g., loss of synchronization. In a load-sharing redundancy configuration, the load-sharing functionality may be handled in hardware instead of software.

Switch system 10 is scalable and the single chassis configuration may accommodate a greater number of line cards 15, system control cards 25 or switch fabric cards 30 than the exemplary embodiment shown in FIG. 1a. For example, in the exemplary embodiment shown in FIG. 1b, the chassis 12 may be populated with dual system control cards 25, three switch fabric cards 30, and 16 line cards 15. The line cards 15 may be of any combination of possible types. As discussed above, line cards 15 may be Fibre Channel line cards, Gigabit Ethernet line cards, cache memory line cards, or any other type of line card. In this particular embodiment, because the single chassis 12 supports 16 line cards 15, switch system 10 has a total of 160 ports (if 10-port lines cards 15 are used). In this particular embodiment, switch system 10 has two system control cards 25, and three switch fabric cards 30. Accordingly, the third switch fabric card 30 and second system control card 25 provide redundant centralized processing and switching fabric functions.

Generally, it is important to ensure that a single failure within a system control card or a switch fabric card does not bring down an entire system. Thus, multiple system control and switch fabric cards, e.g., the two system control cards 25 and three switch fabric cards 30 shown in FIG. 1b, are preferably supported to provide maximum uptime. Redundancy of the line cards 15 is generally not necessary because failures within a single line card typically do not bring down the entire system. Furthermore, such redundancy can be accomplished at the leaf node, e.g., RAID storage devices.

The chassis 12 may have other components. As shown in the exemplary embodiment of FIGS. 1a and 1b, chassis 12 may have hot swappable fan tray 65 or similar thermal management system. Chassis may have line card sub-rack 55 that houses the line cards 15. Chassis 12 may also have air inlet 75 to allow air to move through chassis 10. Fan tray 65 and air inlet 75 may be used to manage thermal conditions within chassis 12. For example, the cool air comes in from air inlet 75, traverses through the line card sub-rack section 55 and is exhaled at the top 65 away from chassis 12. Chassis 12 may also include power chassis 70. Power chassis 70 houses the power supply or supplies for chassis 12 and its components. Note that these components may be placed in any desired configuration.

As discussed above, the number, type and placement of line cards 15 in the chassis 12 may be varied to suit the needs of the user. However, the chassis 12 may contain slots that are specifically adapted for the system control and switch fabric cards. For the exemplary embodiment shown in FIG. 1b, there may be specific slots for each of the two system control cards 25 and three switch fabric cards 30. Preferably, each switch fabric card 30 can handle data traffic with 80 Gbps of bandwidth. The system control cards 25 perform management functions. Each system control card 25 preferably utilizes out-of-band type communication with each individual line card 15. In an alternative exemplary embodiment, in-band communication may be used between system control cards 25 and line cards 15. In another exemplary embodiment, out-of-band bandwidth may be dedicated for the hot-standby redundancy status monitor channel. Alternatively, in-band bandwidth may be used to establish a status monitor channel.

Each system control card 25 may include a memory card 120 for parameter storage and fail-over operation. Each system control card 25 may contain one or more processors. Memory card 120 is preferably 16 MB or larger. In one exemplary embodiment, memory card 120 may be a removable solid-state CompactFlash memory card. Each line card 15 and system control card 25 may include a flash memory component. For example, each line card 15 and system control card 25 may have a minimum of 2 MB of flash memory to support processors, boot flash and other components and functions.

As discussed above, each line card 15 contains one or more network processors 125. In one exemplary embodiment, each line card 15 is capable of handling 10×1 Gbps data ports with five network processors 125. The line card 15 preferably utilizes out-of-band bandwidth to communicate with one or more system control cards 25 as well as other line cards 15. As discussed above, other exemplary embodiments may use in-band communication. The number of line cards 15 determines the number of ports that switch system 10 may have to connect with a switch fabric. With sixteen 10-port line cards 15 installed in a single chassis 12, the users can have up to 160 ports of any combination of Fibre Channel or Gigabit Ethernet ports. For the above-discussed exemplary embodiments, the switch fabric cards are preferably capable of providing 10 Gbps of switch capacity per line card 15. However, the front end of the line card 15 may only support 10 ports at 1 Gbps data rate based on the current technology of the network processors 125.

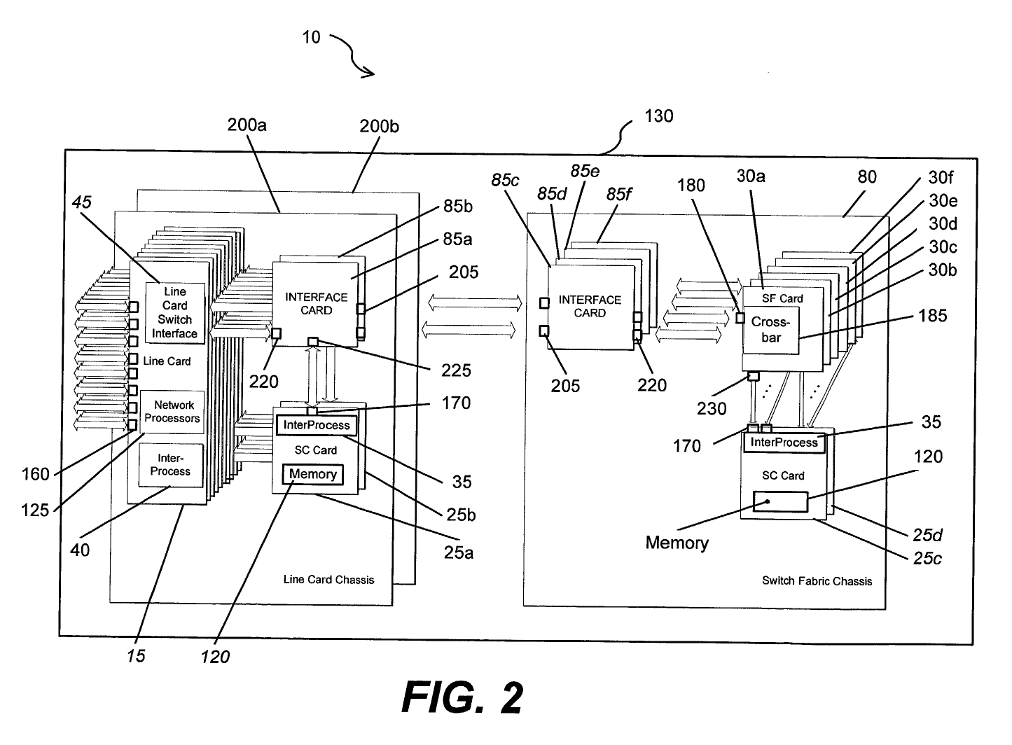

Switch system 10 may be expanded to a multiple-chassis platform, e.g. have more than one chassis 12. This enables a user to have more ports than may be supported by a single chassis 12, e.g., more than 160 ports. FIG. 2 shows a block diagram of an exemplary embodiment switch system 10 configured as a multiple-chassis switch system 130. An external switch fabric chassis 80 is utilized in addition to at least two line card chassis 200. Note that line card chassis 200 may be an expanded version of the line card chassis 12 shown in FIGS. 1A and 1B. Although FIG. 2 depicts two line card chassis 200a and 200b, it should be understood by one of ordinary skill in the pertinent arts that switch system 10 may incorporate more than two line card chassis 200 in the multiple chassis system 130. Each line card chassis 200 contains multiple line cards 15. As discussed above, each line card 15 contains several ports 160 to provide connections with network devices, one or more network processors 125, and a line card switch interface 45. Each line card chassis 200 may also contain one or more system control cards 25. System control cards, shown as 25a and 25b, may provide environmental and fault monitoring, and other functions. Although FIG. 2 shows two system control cards 25a and 25b, it should be understood that more or less system control cards 25 may be used in line card chassis 200 depending on the size of switch system 10 and the desired degree of connectivity. Additional system control cards 25 may be utilized to provide redundancy.

Each line card chassis 200 also contains one or more interface cards, shown as 85a and 85b. Although FIG. 2 shows two interface cards 85a and 85b, the number of interface cards 85 may vary depending on the size of switch system 10 and the desired degree of connectivity. Additional interface cards 85 may be provided for redundancy. Each interface card 85 in the line card chassis 200 may communicatively connect with one or more line cards 15 in the chassis 200 via ports 220 of the interface card 85 and ports 175 (see FIG. 1b) of the line card 15. Each interface card 85 may communicatively connect with one or more system control cards 25 via ports 225 of the interface card and ports 170 of the system control card 25. Accordingly, system control card 25 and line card 15 may be communicatively connected via port 170 on the system control card 25 and port 165 (see FIG. 1b) on the line card 15, e.g., through the interprocess channel. Interface cards 85a-85b may connect to switch fabric chassis 80 via ports 205 to allow line card chassis 200 to communicatively connect with switch fabric chassis 80.

As shown in FIG. 2, switch fabric chassis 80 contains multiple switch fabric cards 30, at least one interface card 85 and at least one system control card 25. In the exemplary embodiment of FIG. 2, switch fabric chassis 80 contains six switch fabric cards 30a-30f. It should be understood by one of ordinary skill in the pertinent arts that the number of switch fabric cards 30 may vary from the number depicted in the exemplary embodiment of FIG. 2 depending on the performance requirements of switch system 10 such as switch size, desired connectivity and redundancy, among other examples. As discussed above, each switch fabric card 30 contains one or more crossbar devices 185.

Switch fabric card 30 also contains ports 180 and 230 for providing a communicative connections with interface cards 85 and system control cards 25, respectively. In the exemplary embodiment of FIG. 2, switch fabric chassis 80 contains two system control cards 25d and 25c and four interface cards 85c-85f. The number of system control cards 25 and interface cards 85 may vary from the number depicted in the exemplary embodiment of FIG. 2 depending on the size of switch system 10 and the desired degree of connectivity. The system control cards 25 and switch fabric cards 30 located in the switch fabric chassis 80 may be used to manage the line card chassis 200. The system control cards 25c and 25d are communicatively connected to the switch fabric cards 30 via ports 170. Interface cards 85c-85f are communicatively connected to switch fabric cards 30 via ports 220. The interface cards 85c-85f are also communicatively connected to line card chassis 200 via ports 205. As a result, interface cards 85c-85f allow switch fabric cards 30 and system control cards 25c-25d to be communicatively connected with line card chassis 200.

In an exemplary embodiment, switch system 10 contains two line card chassis 200 and each line card chassis contains sixteen (16) 10-port line cards 15. Because each line card chassis 200 may contain different types of line cards 15, switch system 10 may contain a total of 32 mixed types of line cards or 320 mixed types of ports. In this exemplary embodiment, the switch fabric chassis 80 is preferably capable of delivering up to 480 Gbps fill duplex bandwidth.

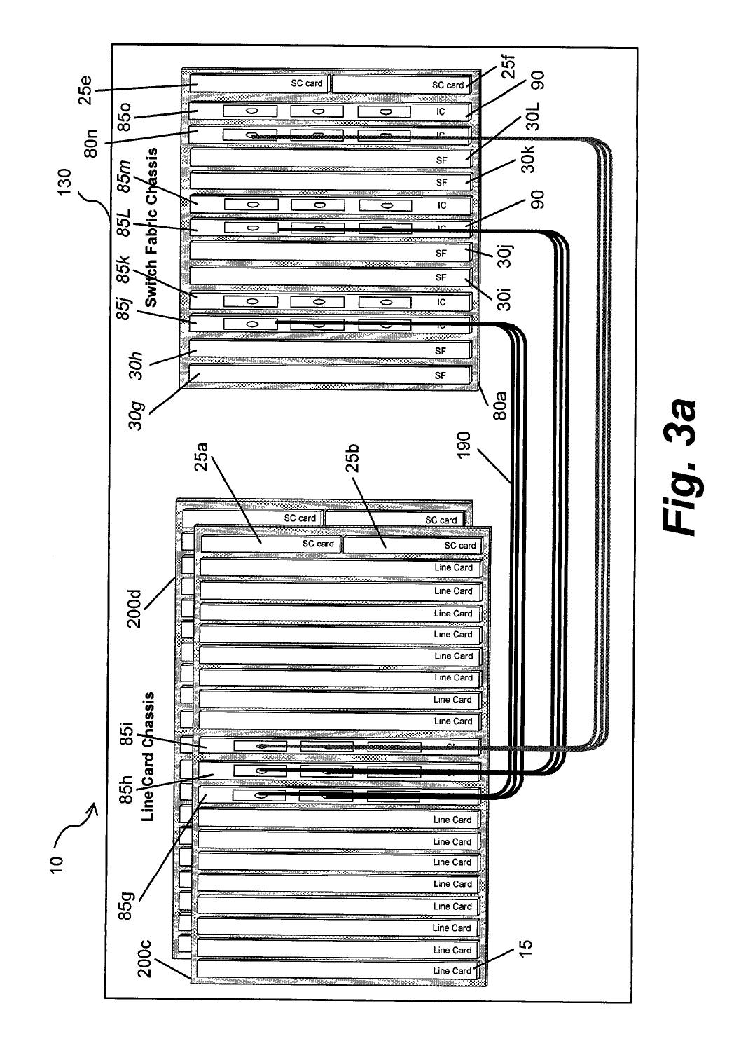

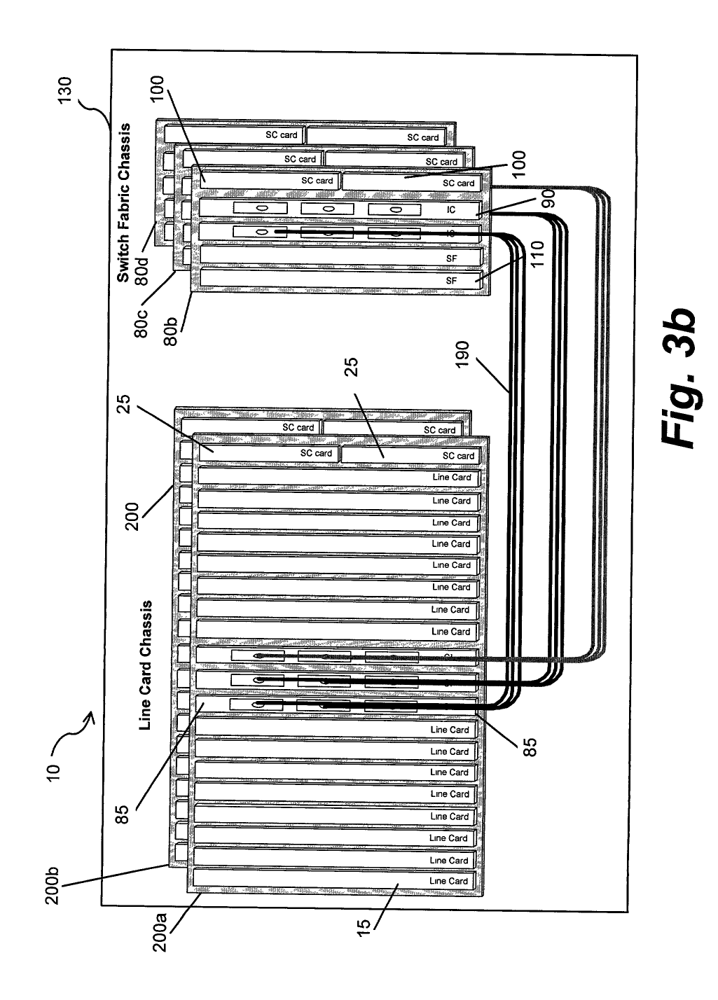

FIG. 3a shows an exemplary embodiment of the interconnections between line card chassis 200c and switch fabric chassis 80a. It should be understood by one of ordinary skill in the pertinent arts that the configuration of line card chassis 200 and switch fabric chassis 80 may vary from the exemplary embodiment shown in FIG. 3a. An existing single chassis 12, as shown in FIG. 1b, may be used in a multiple-chassis configuration 130, as shown in FIG. 2, as a line card chassis 200 by replacing the switch fabric cards 30 with interface cards 85 and system interconnect cables 190. The interconnects 190 may be of any suitable type, such as optical or copper interconnects, for example.

It is possible to convert a single chassis to a multiple-chassis configuration as a live expansion. For example, to perform a live expansion from a 160 port single chassis to a 320 port system, the user may use an external switch fabric chassis 80 with 6 switch fabric cards 30 and 6 system interconnect cables 190, along with an additional 160 port line card chassis 200. These cables 190 connect the switch fabric chassis 80 to multiple line card chassis 200. These 6 switch fabric cards 30 provide connectivity between multiple chassis as well as providing N+1 fabric redundancy. Dual system control cards 25a/25b and 25e/25f are installed to handle system management traffic and failed-over redundancy as well. As discussed above, switch system 10 may also accommodate multiple switch fabric chassis 80 to provide multiple switch fabrics. FIG. 3b shows an exemplary embodiment of the interconnections between line card chassis 200a and multiple switch fabric chassis 80b-80d.

The above-disclosed embodiment is analogous to telecom class equipment that provides 99.999% system availability. Because of the architecture of the switching fabric, even with only one switching fabric card in the system, the component level type of redundancy is provided. A failure of a switch fabric component on one switching fabric card will not affect the total throughput or bring down the system. Full availability may be maintained at all times.

Unlike circuit switching, packet switching does not create dedicated links through the switch but instead rapidly directs individual packets of data from the ingress port to the desired egress port. The fabric switch of the present invention is a packet switch. Switch fabric redundancy comes in the form of excess bandwidth. Part of the switch fabric can fail and there is “extra” bandwidth that can accept the traffic. In a telecom (e.g., circuit switched) environment a switch typically provides twice as much bandwidth as required—implementing an “active” and “standby” path. If any part of the active path fails all traffic is switched over to the standby path. Redundancy can be achieved by simply providing enough extra bandwidth such that when a single component fails there is enough extra bandwidth to absorb the additional traffic. In fabric switch system of the present invention, a single component would typically be considered a single switch fabric card. System redundancy can be achieved if the fabric switch system continues to pass traffic at full speed when one switch fabric card fails.

### Active/Standby Redundancy Configuration

### EXAMPLE 1

The switch system of the present invention may be configured to provide active/standby redundancy. In the active/standby configuration, the switch system includes at least two fabrics. The switch fabric cards or crossbars are designated for either the active fabric or a standby fabric. For example, if there are two fabrics, half of the switching components are designated for each fabric. Traffic is passed on one fabric or the other, but not both. Generally, when one line card experiences a failure, the switch system may switch over to the standby fabric. In this event, all of the other line cards will be instructed to also switch over to the standby fabric.

For example, in an exemplary embodiment utilizing the ZSF202Q and ZSF200X chip sets, the switch system may utilize 32 ZSF200X chips broken into an active fabric of 16 ZSF200X chips and a standby fabric of 16 ZSF200X chips. In this example, each fabric card may have two ZSF200X chips. Up to 64 line cards, each with one ZSF202Q chip, may be configured for 16:16 redundancy and pass traffic on either the active or standby fabric.

A 16:16 configuration, as outlined above, may incur more complex redundancy scenarios. For example, line card #1 that is running on the primary fabric may experience a link failure on its standby interface due to a cable break or an optical transceiver failure. Initially, this situation does not pose a concern because the primary interface is running and no fail over is required. However, if line card #2 experiences a link failure on its primary interface, the question of whether it should be allowed to fail over is presented. If it does fail over, the status of line card #1 must be determined. The line cards can still pass traffic to each other, but now all fabric cards are active. This is an undesirable situation for this configuration because a line card may now experience a link failure on both its primary interface and secondary interfaces. These issues do not arise for a load-sharing configuration.

### Active/Active Redundancy Configuration

### EXAMPLE 1

The switch system of the present invention may also be configured as an active/active redundancy system. The switch system can be designed using load-sharing and multiple ZSF200X chips or switch fabric cards for redundancy. In this configuration, at least two switch fabric cards are active, e.g., a load-sharing configuration, and at least one switch fabric card may serve as a redundant card. However, in an exemplary embodiment of the present invention, the load-sharing may be accomplished through the use of multiple ZSF200X chips, rather than multiple switch fabric cards. For instance, the channels or signal pairs for each line card may be divided between each ZSF200X chip, or each switch fabric card in the switch system, e.g., both the active and redundant ZSF200X chips and/or switch fabric cards. In the load-sharing configuration, each line card would then distribute its traffic across each active ZSF200X chip or active switch fabric card.

Referring to the switch system shown in FIG. 1b to illustrate an exemplary embodiment, each line card 15 may pass all of its signal pairs to the backplane. These signal pairs may be divided into three groups, wherein each group is associated with one of the three switch fabric cards 30. In load-sharing mode, the line cards will automatically distribute their traffic across all of the switch fabric cards. Any of the multiple channels or serial links may fail for a line card, and it will still continue to pass traffic on the other links. No fail over is required, and no other line cards are affected.

In one exemplary embodiment using the ZSF202Q and ZSF200X chip sets, each ZSF202Q chip (e.g., one on each line card) would be configured for 24 channel load-sharing. In load-sharing mode, the ZSF202Q chip may automatically distribute its traffic across all 24 serial links. This embodiment also supports up to 64 line cards.

One difference between the exemplary embodiment of the active/active configuration and the active/standby configuration described above is that, in this particular active/active embodiment, using the ZSF202Q and ZSF200X chip sets, there is a total of 24 ZSF200X chips (e.g., one for each serial channel from the ZSF202Q chips), and all ZSF200X chips carry traffic at the same time. In this configuration, 24 ZSF200X chips have more than twice as much bandwidth as 10 full speed Fibre Channel Class-3 streams. Any of the 24 serial links can fail for a line card, and it will still continue to pass traffic on the other links. No fail over is required, and no other line cards are affected. For some cases, load-sharing is even more fault-tolerant than an active/standby configuration.

For an exemplary system using the ZSF202Q chip set with a burst rate of 12.8 Gbps and ten 1 Gbps line cards, approximately 10 Gbps per ZSF202Q chip is required for switching at the line rate. From the required switching capacity standpoint, there is no difference between the two redundant modes.

The 24-channel load-sharing mode in the above exemplary embodiment of the fabric switch system described above calls for 24 active ZSF200X chips The traffic is shared among the 24 ZSF200X chips. Each ZSF202Q chip monitors the link integrity constantly. When a link fails, the ZSF202Q chip stops sending traffic to that channel, and the fabric switch system runs in a degraded mode. There is no software intervention. The 24-channel load-sharing mode is therefore designed to reduce software interaction with the switch fabric link management.

Generally, the fabric switch system of the present invention may have three states: a single-chassis state, a transition state, and a multi-chassis state. A transition state may occur when the user is changing the configuration of the fabric switch system. For instance, a transition state may occur when the user is changing the configuration from a single-chassis to a multiple-chassis, or vice versa. During normal operation, as a single or multi-chassis state, there is more switching capacity per line card (e.g., per ZSF202Q) in the load-sharing mode. However, during the transition-state, the load-sharing mode may have less switching capacity than an active/redundant system. For example, for a 24-channel configuration, the 24 channel load-sharing mode generally provides less switching capacity than the 16:16 mode in the transition state. Table I below identifies some differences between a 16:16 configuration and a 24-Channel load-sharing configuration for the various states with respect to raw switching capacity. Preferably, the transition state happens infrequently and lasts only for a relatively short period of time.

TABLE I
Comparison of Raw Switching Capacity

| | | | 24-Channel |
|---|---|---|---|
| | | 16.16 | Load-Sharing |
| Max. Raw Switching | Single-Chassis | 20 Gbps | 30 Gbps |
| Capacity Per ZSF202Q | Multi-Chassis | 20 Gbps | 30 Gbps |
| (1.25G* # of links) | Transition | 20 Gbps | 20 Gbps |
| Sustained Switching | Multi-Chassis | 10 Gbps | 10 Gbps |
| Capacity Per Z5F202Q | Transition | 10 Gbps | 10 Gbps |
| Burst Switching | Single-Chassis | 12.8 Gbps | 12.8 Gbps |
| Capacity Per ZSF202Q | Multi-Chassis | 12.8 Gbps | 12.8 Gbps |
| | Transition | 12.8 Gbps | 12.8 Gbps |

The high-speed differential signals running across the backplane may be susceptible to signal distortion. The load-sharing mode reduces the number of traces in the backplane. This increases the chance of backplane layout with better signal integrity. Table II shows a comparison of the signal count between a 16:16 configuration and an exemplary embodiment of a 24-Channel mode switch system.

TABLE II
High Speed Signal Count

| | | 24-Channel |
|---|---|---|
| | 16.16 | Load-Sharing |
| 1.25 Gbps signals per line card | 128 | 96 |
| Total 1.25 Gbps signals in line card chassis | 2048 | 1536 |
| backplane | | |
| High speed signal traces in switch fabric chassis | 6912 | 3072 |
| backplane | | |

### Active/Active Redundancy Configuration

### EXAMPLE 2

The switch system may accommodate a multiple switch fabric configuration. The signal pairs or channel may be divided between the primary switch slot and the secondary switch slot(s). For example, in one exemplary embodiment, the switch system may be designed to accommodate two switch fabric cards, although use of a single switch fabric card is possible with reduced bandwidth performance. For an exemplary embodiment with a 24-channel dual switch fabric configuration, these 24 signals may be split with 12 going to the primary switch slot and the second group of 12 going to the secondary switch slot. A single chassis configuration can operate with a single switch card (e.g., 12 lines). For an exemplary embodiment utilizing the ZSF200X chip set, the switch card may contain three ZSF200X chips and can carry 9.6 Gbits/sec of traffic. For redundancy, a second switch fabric card can be added. Note however, in load-sharing mode the line card (e.g., ZSF202Q) would automatically spread its traffic across both switch fabric cards and both switch fabric cards would be active, even though only one is necessary to carry full traffic.

The multi-chassis, load-sharing configuration may be similar to a typical 16:16 configuration. The single chassis switch slices may be removed and replaced by interface cards, e.g., optical uplink cards. The line card chassis send their traffic over the system interconnect cables, e.g., optic cables, to a separate switch chassis. The number of interface cards and switch slices in the switch chassis depends on the number of switch fabric chassis. For example, for a dual switch fabric configuration, the switch chassis may contain eight interface cards and eight switch slices in one exemplary embodiment. For a triple switch fabric configuration, the switch chassis may contains twelve interface cards and twelve switch slices, for example.

For exemplary embodiments using the ZSF202Q and ZSF200X chip sets, one difference that may be noted in the multiple switch fabric configurations is that each switch slice contains only two or three (e.g., two for triple and three for dual SF configuration) ZSF200X chips for a total of twenty-four ZSF200X chips (e.g., one for each serial channel from the ZSF202Q chips) and all ZSF200X chips carry traffic at the same time. Any potential downside is relatively small because twenty-four ZSF200X chips have almost twice as much bandwidth as 10 full speed Fibre Channel Class-3 streams. Any of the twenty-four serial links can fail for a line card and it will still continue to pass traffic on the other links. No fail over is required, and no other line cards are affected. For example, the system may lose fifteen of its switch links (e.g., five complete switch slices) and still pass full speed traffic. In this respect, load-sharing may be considered more fault tolerant than 16:16 or 1 to 1 redundancy.

### Active/Active Redundancy Configuration

### EXAMPLE 3

The fabric switch system of the present invention may utilize any number of lines depending on the hardware that is utilized, e.g., other than the 24-channel configurations discussed above. To reduce the system serial count link, the above-discussed exemplary embodiments may use chip sets that are configured in a load-sharing mode (e.g. as opposed to 16:16 redundancy). For example, the present disclosure discusses the use of the ZSF202Q and ZSF200X chips in the load-sharing mode. A person of ordinary skill in the pertinent arts should understand that any suitable chip set may be used and the present invention is not limited to the ZSF202Q or ZSF200X chip set discussed herein.

Generally, load-sharing does not place a minimum on the number of lines that need to connect from each line card to each switch fabric card (e.g., from each ZSF202Q to each ZSF200X). However, for a particular selection of chip sets or other components, the system may be limited to a maximum number of lines. For example, for the ZSF202Q and ZSF200X chip sets, the switch system may be limited to a maximum of 24 lines. Regardless of the number of lines available, it is preferable to implement a switch system that can carry full traffic while still providing redundancy for maximum uptime.

Accordingly, for an exemplary embodiment utilizing a minimal configuration, it is desirable to carry about 120 gigabits per second of traffic on a single chassis with a single fabric card with the exemplary components described above (e.g., a 24-channel system with the ZSF200X and ZSF202Q chip sets). Because each ZSF200X can switch 40 Gbps of traffic, the system requires 3 ZSF200X per switch card. Each ZSF200X may be configured in SAP-16 mode when in this chassis, to allow each ZSF200X to export 4 serial lines to each line card for a total of 12 serial lines to each line card from each fabric card. Each line card sends/receives 24 serial channels—12 to each fabric card. When the line chassis is connected to the fabric chassis the 24 signals are spread out across 24 ZSF200X chips—each one running in SAP-64 mode (e.g., one serial link to every line card and up to 64 line cards.)

For the exemplary system described above, 24 Channel load-sharing typically provides a 25% reduction in the high-speed signal count in comparison to a 16:16 mode system. This reduction typically corresponds to a reduction the fabric chassis backplane trace count from about 8192 to about 6144. The system may utilize load-sharing with fewer than 24 channels and reduce the high-speed signal count even more.

For example, a system can be implemented with only 18 channels to each line card. The ZettaCom chip set provides 622 Mbps of user-payload capacity per serial channel. Under normal operating conditions all 18 channels will be in operation for each line card and each line card will have over 11 Gbps of switch fabric bandwidth available. However, if these signals are split equally between three fabric cards and one of the fabric cards is removed or fails each line card will only have 12 channels, or 7.5 Gbps of bandwidth, available. If the line card does not require more than 7.5 Gbps of switch capacity or if the system can tolerate operating at less than peak performance 18 channel load-sharing can provide an additional 25% reduction in high speed signal count, saving cost and design complexity.

Table III below lists some differences between exemplary embodiments of 18 channel and 24 channel load-sharing systems.

TABLE III
Comparison of 18-Channel to 24-Channel Load-sharing

| | 18 Channel | | 24 Channel | |
|---|---|---|---|---|
| ZSF200X chips per switch card | 2 | | 2 | |
| Switch cards in single chassis | 3 | | 3 | |
| Switch cards in fabric chassis | 9 | | 12 | |
| 1.25 Gbps serial links from each ZSF202Q | 18 | | 24 | |
| Peak fabric bandwidth per line card | 11.2 | Gbps | 14.9 | Gbps |
| Single chassis bandwidth with one fabric card operational | 7.5 | Gbps | 10 | Gbps |
| Multi-chassis line card bandwidth if one switch slice fails | 10 | Gbps | 13.7 | Gbps |
| Multi-chassis line card bandwidth if two switch slices fail | 8.7 | Gbps | 12.4 | Gbps |
| 1.25 GHz pins on each line card | 72 | | 96 | |
| 1.25 GHz traces in line card backplane | 1152 | | 1536 | |
| 1.25 GHz traces in fabric backplane | 4608 | | 6144 | |
| 1.25 Gbps optical signals per optic card | 288 | | 384 | |

### Active/Active Redundancy Configuration

### EXAMPLE 4

The present fabric switch system may be implemented at various Gigabit Ethernet configurations. For example, one embodiment of the present invention may be implemented using a 2.5 Gbps mode instead of the 1.25 Gbps mode discussed above. In one exemplary embodiment, the switch fabric card may have 2 ZSF200X devices. These devices are 64-port switches. These devices support multiple modes, such as SAP-64, SAP-32, and SAP-16, for example. In SAP-64 mode, the ZSF200X device is a single 64-port switch. In SAP-32 mode, the ZSF200X device is divided into 2 independent 32-port switches. In SAP-16 mode, the ZSF200X is divided into 4 independent 16-port switches.

In this exemplary embodiment, each line card may have 24 1.25 Gbps serial links connected to the switch fabric. In a single chassis solution with 16 line cards, the ZSF200X on the switch fabric card may be configured in a SAP-16 mode.

Three switch fabric cards provide six ZSF200X devices. Six ZSF200X devices in SAP-16 mode provide 16-port switches which are needed for the 24 serial lines from each line card. Each serial link from the line card connects to the associated port of the 16-port switch. Line card 0 connects to port 0, line card 1 connects to port 1, etc.

A 320-port switch system requires 32 10-port line cards. To support 32 line cards, a 32-port switch is generally required, so the ZSF200X devices are re-configured to the SAP-32 mode. Six switch fabric cards provide 12 ZSF200X devices. Twelve ZSF200X devices in SAP-32 mode provide 32-port switches that are needed for the 24 serial lines from each line card. Each serial link from the line card connects to the associated port of the 32-port switch. Line card 0 connects to port 0, line card 1 connects to port 1, etc.

The fabric switch system of the present invention provides a reliable system that overcomes several disadvantages associated with the prior art, including dual redundancy systems. Generally, the fabric switch system offers improvements from an electrical, thermal and mechanical standpoint by reducing the number of components and signals. Furthermore, the present invention provides software control benefits because the fabric switch system does not require software to monitor the operation of two fabrics and to manage the fail-over process.

Another advantage of the present invention is that load-sharing redundancy reduces the high speed signal count for a system. For example, in the exemplary embodiments described above, load-sharing redundancy may reduce the high speed signal count by 25% in comparison to dual redundancy. Table IV below compares the signal count characteristics of an exemplary embodiment of a load-sharing system to an example dual redundancy system. The reduced signal count also provides the additional advantage of reducing the number of pin-outs. A smaller number of pin-outs allows for less complex backplane designs.

TABLE IV
Comparison of Signal Counts

| | 16:16 | 24 channel |
|---|---|---|
| | Mode | load-sharing |
| 1.25 GHz signals per card | 128 | 96 |
| Total 1.25 GHz signals in backplane | 2048 | 1536 |
| Signal connections per SF card | 1024 | 512 |
| Signals connections for optical card | 1024 | 512 |
| Line card signal traces in fabric backplane | 6912 | 3072 |

Another advantage of the present invention is lower connector density. Because connectors are generally available in fixed sizes (for example, 50 or 100 signals per connector) it is possible to save considerable edge connector length by minimizing the number of signal pins that are required. Because less number of backplane pins are required, the connector cost for the system may be reduced. In the case of 16:16, most of the signal counts will require the design to add an extra connector for only a few signals. Additionally, reducing the connector count will reduce the force required for insertion and removal of the cards, e.g., a lower number of ZSF200X chips per switch fabric card requires less insertion force. The force is not insubstantial when dealing with 1000 pins, for example. Accordingly, another advantage is to reduce wear and tear on the components.

Additionally, depending on the configuration of the fabric switch system, the reduced signal count may facilitate system connectivity. For example, if the system utilizes optical connections and line cards with twelve signals, an optical transmitter/receiver pair nicely carries 12 channels of traffic that matches up with the twelve signals from each line card.

Another advantage of the present invention is reduced power consumption. In the typical 16:16 design, the switch fabric effectively generates 50% more heat because half of the cards are redundant and not passing traffic. A typical fabric chassis will dissipate something on the order of 4000W of power, although that power consumption may be less. This number may be significantly reduced in the present invention by using 25% fewer ZSF200X chips. Note that this also reduces the number of other components, e.g., SERDES and optical transceivers, and may result in a further reduction of power consumption and heat generation. The estimated power savings for an exemplary embodiment of the present invention are listed in Table V. In the example shown in Table V, the total estimated power savings may be between 640 to 720 watts.

TABLE V
Switch Shelf Power Consumption

| | Switch Shelf | | |
|---|---|---|---|
| | Typical/ | Number | Power |
| | Max (W) | Removed | Saved (W) |
| ZSF200X | 8.5/8.5 | 8 | 68 |
| Quad SERDES | 2.9/3.6 | 128+ | 370 to 460 |
| Optical Transmitter | 2.4/2.4 | 40 | 96 |
| Optical Receiver | 2.4/2.4 | 40 | 96 |

Power savings may also be found in the line card chassis. Table VI shows the power savings for the line card shelf for an exemplary embodiment of the present invention. In the example shown in Table VI, the total estimated power savings for the line card shelf may be between 197 to 247 watts.

TABLE VI
Line Card Shelf Power Consumption

| | Line Card Shelf (single shelf configuration) | | |
|---|---|---|---|
| | Typical/Max (W) | Number Removed | Power Saved (W) |
| ZES ZSF200X | 8.5/8.5 | 2 | 17 |
| Quad SERDES | 2.9/3.6 | 64 | 185 to 230 |

Another advantage of the present invention is that less complex software may be used to manage the system. Load-sharing allows for less complex control software because the switch is no longer required to manage both an active and standby fabric. Line cards that experience link failures may simply report the failed link to the system control card. The control software can report this error for diagnostic purposes and can generate alarms in too many links fail.

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is to be limited only by the spirit and scope of the appended claims, giving full cognizance to equivalents in all respects.

What is claimed is:

1. A switch system communicatively connected with a computer network, the switch system comprising:
a line card comprising a plurality of ports each operable to provide communicative connections with a network device;
a set of active switch fabric cards comprising a first and second switch fabric card to provide switching functionality between the computer network and the line card, wherein the first and second switch fabric card are operable to concurrently carry network traffic; and
a first system control card to provide control functionality for the line card.

2. The switch system of claim 1, further comprising a plurality of line cards.

3. The switch system of claim 2, wherein at least one line card is a Fibre Channel line card operable to handle traffic in accordance with a Fibre Channel protocol.

4. The switch system of claim 2, wherein at least one line card is an Ethernet line card operable to handle traffic in accordance with an Ethernet protocol.

5. The switch system of claim 2, wherein at least one line card is a cache memory line card operable to cache data.

6. The switch system of claim 1, further comprising a third switch fabric card that is operable to serve as a redundant switch fabric card such that the third switch fabric card is operable to serve as an active switch fabric card if the first or second switch fabric card fails.

7. The switch system of claim 1, further comprising a second system control card to serve as a redundant control card such that the second system control card is operable to serve as an active system control card if the first system control card fails.

8. The switch system of claim 1, wherein the line card further comprises a line card switch interface operable to communicative connect with the active switch fabric cards via a plurality of channels.

9. The switch system of claim 8, wherein the channels are high-speed serial links.

10. The switch system of claim 8, wherein each channel is associated with an active switch fabric card such that network traffic is distributed between the active switch fabric cards.

11. The switch system of claim 8, wherein each switch fabric card further comprises a crossbar to provide a communicative connection between the switch fabric card and the line card.

12. The switch system of claim 11, wherein the line card switch interface is operable to monitor the connection between the line cards switch interface and a crossbar and disable any channel with a crossbar in which the line card switch interface has detected a critical error.

13. The switch system of claim 12, wherein the line card switch interface is operable to stop sending traffic to a crossbar without intervention from a software agent.

14. The switch system of claim 1, further comprising:
an first active switch fabric comprising the set of active switch cards; and
a set of standby switch fabric cards operable to serve as a standby switch fabric such that the standby switch fabric is operable to serve as an active switch fabric if the first active switch fabric fails.

15. A switch system communicatively connected with a computer network, the switch system comprising:
a line card chassis; and
a switch fabric chassis.

16. The switch system of claim 15, further comprising a plurality of line card chassis.

17. The switch system of claim 15, further comprising a plurality of switch fabric chassis.

18. The switch system of claim 15, wherein the line card chassis comprises:
a plurality of line cards each comprising a plurality of ports each operable to provide communicative connections with a network device;
a first system control card communicatively connected to the line cards to provide monitoring control functionality; and
a first interface card to provide a communicative connection between the line card chassis with the switch fabric chassis.

19. The switch system of claim 16, wherein the switch fabric chassis comprises:
a set of active switch fabric cards to provide switching functionality between the computer network and the line card chassis, wherein the switch fabric cards are operable to concurrently carry network traffic;
a first system control card communicatively connected to the switch fabric cards to provide control functionality; and
a first interface card to communicatively connect the switch fabric chassis with the line card chassis.

20. The switch system of claim 19, wherein at least one line card is a Fibre Channel line card operable to handle traffic in accordance with a Fibre Channel protocol.

21. The switch system of claim 19, wherein at least one line card is a Gigabit Ethernet line card operable to handle traffic in accordance with a Gigabit Ethernet protocol.

22. The switch system of claim 19, wherein at least one line card is a cache memory line card operable to cache data.

23. The switch system of claim 19, wherein the line card chassis further comprises a second system control card to serve as a redundant control card such that the second system control card is operable to serve as an active system control card if the first system control card fails.

24. The switch system of claim 19, wherein the switch fabric chassis further comprising a second system control card to serve as a redundant control card such that the second system control card is operable to serve as an active system control card if the first system control card fails.

25. The switch system of claim 19, wherein the line cards each comprise a line card switch interface operable to communicative connect with the active switch fabric cards via a plurality of channels.

26. The switch system of claim 25, wherein the channels are high-speed serial links.

27. The switch system of claim 25, wherein each channel is associated with an active switch fabric card such that network traffic is distributed between the active switch fabric cards.

28. The switch system of claim 27, wherein each switch fabric card further comprises a crossbar to provide a communicative connection between the switch fabric card and the line card.

29. The switch system of claim 28, wherein the line card switch interface is operable to monitor the connection between the line cards switch interface and a crossbar and disable any channel with a crossbar in which the line card switch interface has detected a critical error.

30. The switch system of claim 29, wherein the line card switch interface is operable to stop sending traffic to a crossbar without intervention from a software agent.

31. The switch system of claim 15, further comprising:
an first active switch fabric comprising the set of active switch cards; and
a set of standby switch fabric cards operable to serve as a standby switch fabric such that the standby switch fabric is operable to serve as an active switch fabric if the first active switch fabric fails.

32. The switch system of claim 15, further comprising a power supply to provide power to the switch system.

33. The switch system of claim 32, further comprising a power supply chassis comprising the power supply.

34. The switch system of claim 15, further comprising an air inlet.

35. The switch system of claim 34 further comprising a fan tray operable to provide air movement from the air inlet through the switch system to provide a thermal management functionality.

36. A method for providing switching functions for network traffic across a computer network, comprising the steps of:
providing a line card comprising a plurality of ports each operable to provide communicative connections with a network device;
providing a set of active switch fabric cards comprising a first and second switch fabric card to provide switching functionality between the computer network and the line card, wherein the first and second switch fabric card are operable to concurrently carry network traffic; and
providing a first system control card to provide control functionality for the line card.

37. The method of claim 36 further comprising the step of distributing network traffic across both the first and second switch fabric cards.

38. The method of claim 37, further comprising the step of providing a third switch fabric card to serve as a redundant switch fabric card.

39. The method of claim 38, further comprising the step of failing over to the third switch fabric if the first or second switch fabric card fails.

40. The method of claim 37, further comprising the step of providing a second system control card to serve as a redundant system control card.

41. The method of claim 40, further comprising the step of failing over to the second system control card if the first system control card fails.

42. A switch system communicatively connected with a computer network, the switch system comprising:
a first line card chassis; and
a second line card chassis.

43. The switch system of claim 42, further comprising a plurality of line card chassis.

44. The switch system of claim 42, wherein the first line card chassis comprises:
a plurality of line cards each comprising a plurality of ports each operable to provide communicative connections with a network device;
a first system control card communicatively connected to the line cards to provide monitoring control functionality; and
a first interface card to provide a communicative connection between the first line card chassis with the second line card chassis.

45. The switch system of claim 43, wherein the second line card chassis comprises:
a set of active switch fabric cards to provide switching functionality between the computer network and the first line card chassis, wherein the switch fabric cards are operable to concurrently carry network traffic;
a first system control card communicatively connected to the switch fabric cards to provide control functionality; and
a first interface card to communicatively connect the second line card chassis with the first line card chassis.

46. The switch system of claim 45, wherein at least one line card is a Fibre Channel line card operable to handle traffic in accordance with a Fibre Channel protocol.

47. The switch system of claim 45, wherein at least one line card is a Gigabit Ethernet line card operable to handle traffic in accordance with a Gigabit Ethernet protocol.

48. The switch system of claim 45, wherein at least one line card is a cache memory line card operable to cache data.

49. The switch system of claim 45, wherein the first line card chassis further comprises a second system control card to serve as a redundant control card such that the second system control card is operable to serve as an active system control card if the first system control card fails.

50. The switch system of claim 45, wherein the second line card chassis further comprising a second system control card to serve as a redundant control card such that the second system control card is operable to serve as an active system control card if the first system control card fails.

51. The switch system of claim 45, wherein the line cards each comprise a line card switch interface operable to communicative connect with the active switch fabric cards via a plurality of channels.

52. The switch system of claim 51, wherein the channels are high-speed serial links.

53. The switch system of claim 51, wherein each channel is associated with an active switch fabric card such that network traffic is distributed between the active switch fabric cards.

54. The switch system of claim 53, wherein each switch fabric card further comprises a crossbar to provide a communicative connection between the switch fabric card and the line card.

55. The switch system of claim 54, wherein the line card switch interface is operable to monitor the connection between the line cards switch interface and a crossbar and disable any channel with a crossbar in which the line card switch interface has detected a critical error.

56. The switch system of claim 55, wherein the line card switch interface is operable to stop sending traffic to a crossbar without intervention from a software agent.

57. The switch system of claim 42, further comprising:
an first active switch fabric comprising the set of active switch cards; and
a set of standby switch fabric cards operable to serve as a standby switch fabric such that the standby switch fabric is operable to serve as an active switch fabric if the first active switch fabric fails.

58. The switch system of claim 42, further comprising a power supply to provide power to the switch system.

59. The switch system of claim 58, further comprising a power supply chassis comprising the power supply.

60. The switch system of claim 42, further comprising an air inlet.

61. The switch system of claim 60 further comprising a fan tray operable to provide air movement from the air inlet through the switch system to provide a thermal management functionality.
